(19) United States
(12) Patent Application Publication
(10) Pub. No.: US 2007/0114045 A1
(43) Pub. Date: May 24, 2007

(54) Inflatable horseshoe support pad

(75) Inventors: Patrick J. Morris, Santa Rosa, CA (US); Mark Pound, Napa, CA (US); Kevin Graham, Santa Rosa, CA (US)

Correspondence Address: DERGOSITS & NOAH LLP, FOUR EMBARCADERO CENTER, SUITE 1450, SAN FRANCISCO, CA, 94111, US

(73) Assignee: Airshod, Inc.

(21) Appl. No.: 11/639,510

(22) Filed: Dec. 16, 2006

Related U.S. Application Data
(63) Continuation-in-part of application No. 10/557,034, filed on Nov. 15, 2005.

(51) Int. Cl. A01L 7/02

(52) U.S. Cl. 168/14

(57) ABSTRACT

An inflatable horseshoe support pad for preventing and treating laminitis and navicular syndrome, among other maladies, including a body member and an inflatable bladder. The inflatable horseshoe pad is mounted between the hoof of the horse and the horseshoe with the bladder mounted on the upper surface of the body member near the heel portion so that it engages the frog of a horse's hoof when installed on the hoof. The support pad is mounted under the bladder. A frog pad can also be mounted under the support pad.

### CROSS REFERENCE TO RELATED PATENT APPLICATIONS

The present application is a continuation in part of U.S. patent application Ser. No. 10/557,034, “Inflatable Horseshoe Support Pad” filed May 16, 2003.

### TECHNICAL FIELD

The present invention relates generally to farriery, more particularly to an inflatable horseshoe support pad, and a method for use thereof, for interposition between a conventional metal horseshoe and a horse's hoof to protect and stimulate the soft tissue of the hoof and thereby to assist in the prevention and treatment of the equine diseases of laminitis and other problems of lameness.

### BACKGROUND

Equine founder or laminitis is a debilitating disease which, if left untreated and unarrested, may lead to progressively more serious sequella and possibly death. Disease pathology includes an inflammation and degradation of the laminae while secures the hoof wall to the coffin bone, resulting in a separation of the hoof wall from the coffin bone. The weight of the animal systematically rotates the coffin bone downwardly, while simultaneously deforming the hoof wall forwardly. Compensating for and guarding against the concomitant pain, the horse will redistribute its weight rearward and toward the heel. This simply exacerbates the problem by increasing the load on the coffin bone.

A classic reference on equine foot anatomy and pathology, The Foot of the Horse, by David Roberge, indicates that the fundamental cause of founder is an imbalance in the condition of the feet. [The Foot of the Horse, Roberge, David, pp. 180-181, Lessiter Publications, Inc., Brookfield, Wis. 2001.]

Accepted and established treatments for founder include shoeing with corrective shoes, sometimes with the addition of therapeutic pads interposed between the shoe and hoof. Numerous patents reflect the efforts of those with skill in the art to provide effective treatment for founder. Many such treatments entail the installation of a shock-absorbing pad, interposed between a horseshoe and the hoof sole, extending to cover substantially the entire hoof sole, and occasionally including surface structure to cover the frog portion of the hoof. These devices and methods of treatment provide a measure of support for the frog, however they also import several liabilities, including rapid wear and deterioration of effectiveness, exposure of the sole through the back of the heel portion to contaminants and irritating debris, or exacerbation of pathology by increased hoof imbalance. Exemplary are the following.

U.S. Pat. No. 6,283,219 to Fyer, discloses a plastic form conforming to the shape of the underside of an equine hoof and within the borders of the hoof wall that is affixed to the hoof by means of straps or adhesive tape. The function of the form is to support the sole and skeletal structure of the hoof while the hoof wall remains unsupported, the purpose being to allow the hoof wall to grow out undistorted following the occurrence of laminitis or founder. The plastic form can have additional thickness at the heel area to raise the angle of heel, reducing tension in the suspensor ligaments and flexor tendons attached to the coffin bone and thereby allowing the coffin bone to return to its normal position. The form can be cushioned to allow for sensitive hoof soles.

U.S. Pat. No. 5,509,484 to Landi et al, teaches a horseshoe shock-absorbing impact pad for horses including a generally oval-shaped panel truncated on one side to have an outer perimeter configured to correspond to the hoofprint of a horse. The panel is made of a relatively firm, resilient material, and includes a honeycomb-configured core having a first sheet of resilient material bonded to one face of the core and a second sheet of resilient material bonded to the opposite face of the core to form a plurality of hermetically sealed cells. The core comprises bonded together first and second regions. The first region having a plurality of strips of thermoplastic material having a first stiffness characteristic, bonded together along a plurality of first bond joints to form a plurality of contiguous regular shaped cells. The second region similarly having a plurality of strips of thermoplastic material having a second stiffness characteristic, bonded together along a plurality of second bond joints to form a plurality of contiguous regular shaped cells. Each of the first and the second bond joints form a first and a second bond row, respectively. Each of the first and the second bond rows are parallel to one another and are perpendicular to the longitudinal axis of the panel. When the pad is placed between a horseshoe and horse's hoof the pad tends to absorb a substantial part of the shock energy that would otherwise be transmitted to the hoof.

U.S. Pat. No. 5,167,227 to Meserlian, shows a device for massaging the legs of a horse, while also providing controllable air cushion support, includes a boot for encasing at least one foot of a horse, the boot including a flexible tube extending through the boot to permit circulation of a fluid through the boot. The flexible tube includes an inlet and an outlet. The device further includes a supply of water; an inlet conduit which supplies the water from the supply to the inlet of the flexible tube; an outlet conduit which conveys the water from the outlet of the flexible tube back to the supply; a water pump which pumps the water from the supply to the inlet conduit to control the temperature of each foot of the horse; an air pump which simultaneously pumps air from an air conduit to the inlet conduit in mixing relation with the water to such an extent that the air provides a massaging action to each foot of the horse; and an air bladder which provides regulated support for the sole of the hoof of each foot in order to aid in healing of the foot during laminitis, the air bladder being positioned within the boot and beneath the sole of the hoof of each foot; and a pressure bulb which inflates the air bladder to a desired pressure.

U.S. Pat. No. 4,794,991 to Honderich, discloses a device for the treatment of laminitis in a horse, comprising a plate member sized, shaped and adapted for fastening to the hoof of the horse, the plate member including a concave upwardly projecting portion for rotating an out of position coffin bone of the horse into its normal position and maintaining the coffin bone in the normal position for healing. The apparatus includes a U-shaped support member extending from the top of the upwardly projecting portion, for providing additional support and positioning of the coffin bone of the horse, a cushioning member, positioned on top of the plate member and the support member, for cushioning the bottom of the foot of the horse; and a bonding layer of hardened rubber for fastening the support member and the cushioning member to the plate member, the U-shaped support member being an integral portion of the bonding layer.

Many other horseshoe designs are intended to reduce shock and thereby to reduce susceptibility to injury. For instance, U.S. Pat. No. 6,488,096, to Asakawa, teaches a hoof pad used in combination with a horseshoe, with the pad having a flexible plate and a plurality of catches. The flexible plate is partially elliptically shaped to match the inner edge of the shoe. The catches are formed on the top surface of the plate and extend outwardly so that the catches can be secured on the inside of the shoe so that the plate has the same height as the top of the shoe.

U.S. Pat. No. 6,244,352 to Luber shows a shoeing apparatus comprising a shoe and shoe insert made of shock-absorbing material between the hoof and shoe. The single-part or multiple-part insert is matched to the shape of the horseshoe and is nailed in the front area between the hoof and shoe and can move in the rear area with the hoof relative to the shoe. This mobility is ensured by a sliding member situated between the insert and the shoe and capable of moving relative to the shoe. In the heel area, the insert is provided on its inner side with beading which both permits and restricts displacement of the insert.

A clever alternative to conventional horseshoe pads is disclosed in U.S. Pat. No. 6,009,952, to Porteous, et al, which teaches a method of protecting a horse hoof by injecting a synthetic organic resin such as a urethane resin in the volume defined by the horse hoof bottom wall, suitably covered with a web fixed to the hoof bottom wall that is adhered to the resin. The resin protection is suitably free flowing into place, conforms to the contours of the hoof bottom wall, and adheres to the wall when cured. The protection by the resin is resilient and softer than the hoof wall and acts to cushion the hoof against shock.

U.S. Pat. No. 5,533,575, to Brown, shows a horseshoe fabricated of elastomeric material. The shoe has a peripheral configuration corresponding to the peripheral configuration of the sole of an equidae hoof and a cross section of substantially uniform thickness. The shoe includes a tread and a ply, which has sufficient thickness and strength to hold any nails used to attach the shoe to a hoof. The shoe purportedly provides protection to the underside of the hoof, including the frog.

U.S. Pat. Nos. 5,303,777, to Zook, discloses a horseshoe having reinforced belting material as padding. The belting material is cut to a certain depth in selected locations and may be removed along the layers of reinforcing material. A truncated toe portion of a horseshoe is adhesively bonded to the turf side of the toe portion of the pad. The reinforcing material provides lateral stability to the padding allowing a thicker pad with the same stability. The padding may also be molded from rubber or plastic with a turf side of the toe portion recessed to accommodate the truncated horseshoe.

U.S. Pat. No. 4,565,250, to Vasko, teaches a horseshoe pad formed of a shock absorbing layer and a stabilizing fabric layer. The shock absorbing layer is a dense non-cellular polyurethane having a compression set of less than 15%, and preferably less than 5%, an elongation at break of at least 500%, a recovery after compression which is delayed by about 0.7 seconds, and a hardness on the Shore 00 scale of approximately 70. The fabric reinforcing layer may be a woven nylon fabric. In addition to these two layers, some embodiments include an additional layer of stabilizing fabric on the opposite side of the shock absorbing layer and/or layers of polyester urethane forming base and/or top layers. The pad may be used both between a plastic or a conventional metal horseshoe and the hoof, or the pad may be shaped to fit free-floatingly within the interior hoofwall and held in place only by an underlying sheet of material which is in turn secured in place by a conventional horseshoe.

Of the many designs and improvements in the art, including those detailed above, to date there is yet no known horseshoe pad providing an inflatable gas or foam filled bladder that may be interposed between a horseshoe and a horse's hoof.

### SUMMARY OF THE INVENTION

The present invention is an inflatable horseshoe support pad specifically adapted for use in preventing and treating laminitis, navicular syndrome and other problems of lameness. The inflatable horseshoe support pad is a pliable device that fits between the horseshoe and the horse hoof. The support pad includes a first layer that is made of a rigid plastic and/or hard rubber material that is roughly the shape of the horseshoe. The inventive support pad also includes an inflatable bladder that is formed in a softer rubber and mounted to the upper surface of the first layer towards the rear center. A valve is coupled to the inflatable bladder so that the bladder can be filled with a compressible fluid. The valve also allows the internal pressure of the bladder to be adjusted. When the bladder is properly inflated, it provides support for the frog and hoof. The inventive support pad is held in place by the nails used to secure the shoe to the hoof as well as the compression of the inventive support pad between the horseshoe and hoof. The support pad may also include a frog pad that is mounted to the bottom of the first layer so that it is partially surrounded by the horseshoe.

It is an object of the present invention to provide a horseshoe support pad that provides therapeutic relief and support for the prevention and treatment of diseases of the foot such as laminitis (founder), navicular syndrome and other problems of lameness. The inventive horseshoe support pad has an inflatable bladder that supports the frog. The present invention to provide a horseshoe support pad that stimulates the function of the digital cushion and enhances digital circulation resulting in stimulated growth. The inventive horseshoe support pad also promotes normal hoof development and provides optimum relationships between the toe and heel regions of the hoof. Yet another benefit of the present invention is that it maintains and re-establishes the dynamic arch of the sole.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an exploded perspective view of the elements for shoeing a horse with the inventive inflatable horseshoe pad of the present invention;

FIG. 2 is a top plan view of the inventive apparatus, showing in phantom the outer edge of a horseshoe when the shoe is in the preferred position when installed;

FIG. 3 is a bottom view of the inventive apparatus, again showing in phantom the preferred position of a horseshoe upon installation;

FIG. 4 is a side view in elevation of the inflatable horseshoe support pad;

FIG. 5 is a rear view in elevation thereof;

FIG. 6 is a cross-sectional view in elevation of the inventive apparatus installed with a horseshoe on a horse's hoof;

FIG. 7 is a cross-sectional view in elevation of the inventive horseshoe installed on a horse's foot and showing an alternative placement for the bladder valve;

FIG. 8 is a cross-sectional side elevation view of a second preferred embodiment of the inflatable horseshoe support pad of the present invention;

FIG. 9 is a cross-sectional side elevation view of a preferred embodiment of the valve assembly; and

FIG. 10 is a side elevation view of a preferred embodiment of the valve assembly;

FIG. 11 is a side elevation view of a preferred embodiment of the valve assembly with the filling mechanism inserted;

FIG. 12 is a diagram of the valve, filling mechanism and a gas pressure control system;

FIG. 13 is a side view of an alternative valve; and

FIG. 14 is a top view of an alternative valve.

### DRAWING REFERENCE NUMBERS

100 first preferred embodiment of inventive inflatable horseshoe pad
102 body member
103 toe portion
103a forward point of toe portion
104 heel portion
105 upper, hoof-facing surface of body member
106 outer edge
107 lower, ground-facing surface of body member
108 inflatable bladder
110 first layer
112 second layer
112a forward point of second layer
114 rear side (of bladder)
116 back edge of body member
118 trimming portion
horseshoe
122 outside edge of horseshoe
124 hoof
126 frog pad
126a tip of frog pad
128 fore portion of the frog
130 frog
132 valve
134 passage
136 bladder chamber
139 valve cover
151 valve stem
152 centerbore of valve stem
153 open end of valve stem
155 sealing end of valve stem
157 slot
159 sleeve
161 filling mechanism
163 filling tube
165 hole
167 vent valve
169 fill valve
171 pressurized gas source
173 pressure gage
175 filling system
181 valve stem
183 open end
185 sealing end

### DETAILED DESCRIPTION

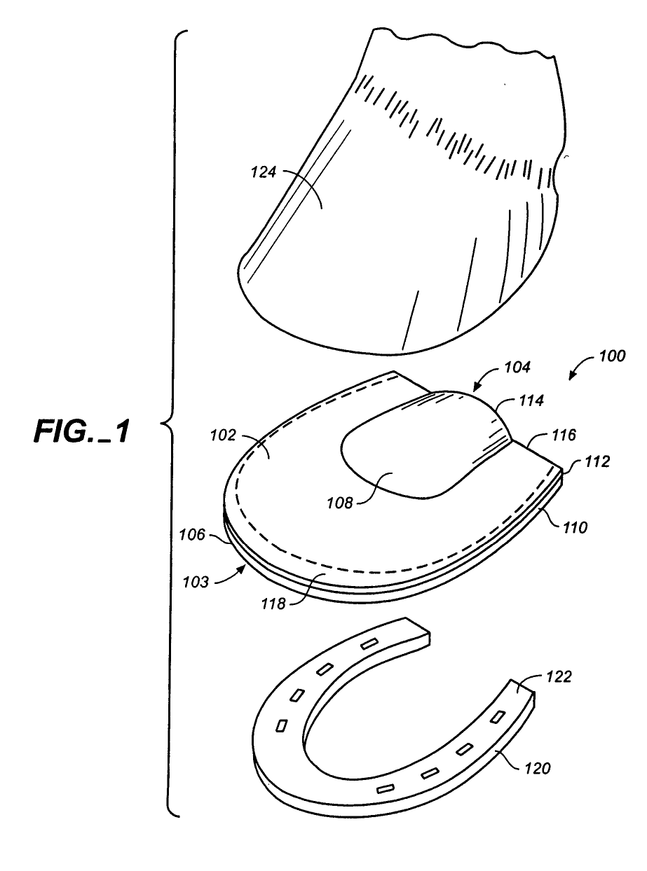

Referring to FIGS. 1 through 6, wherein like reference numerals refer to like components in the various views, there is illustrated therein a new and improved horseshoe support pad, generally denominated 100 herein.

FIG. 1 illustrates a first preferred embodiment of the inventive apparatus, showing that the pad generally comprises a substantially planar body member 102 having a toe portion 103, a heel portion 104, an upper, hoof-facing surface 105, a partially elliptical outer edge 106, a lower, ground-facing surface 107, and an inflatable bladder 108. In a first preferred embodiment, the body member comprises a first layer 110 of elastomeric material (such as rubber, including natural rubber, synthetic rubber, and/or combinations thereof), or plastic, and a second layer 112, also fabricated from elastomeric material or plastic, the second layer being welded, glued, or otherwise permanently affixed to the first layer in a manner known to those with skill in the art. Affixation of the second layer includes the entire area of the layers excluding the area defined by the bladder 108, such that the layers form a pocket for injection of gas or compressible material. Proximate the heel portion 104 of the body member, the rear side 114 of the bladder 108 extends substantially co-linearly along the back edge 116 of the body member.

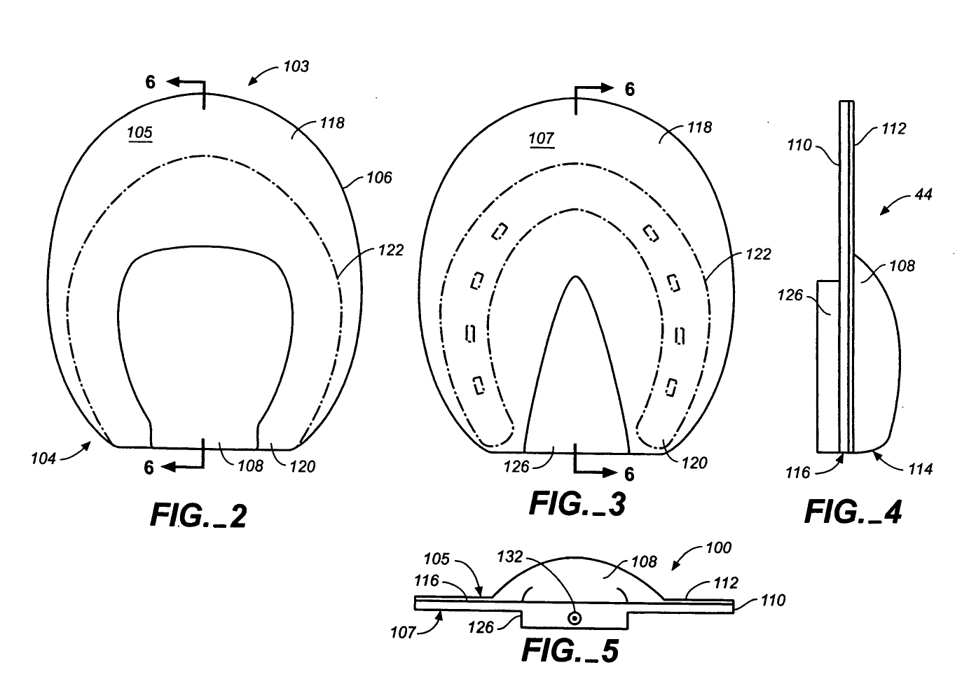

The planar body member and the inflatable bladder are sized according to the size of the hoof to be shoed. The body member preferably includes a trimming portion 118 which is intended to extend beyond the outside edge 122 of a horseshoe 120. When installed on a hoof 124, the trimming portion 118 may be cut off so that the outside edge 106 of the body member and the outside edge 122 of the shoe 120 are substantially flush. The preferred position of the horseshoe is shown in FIGS. 2 and 3.

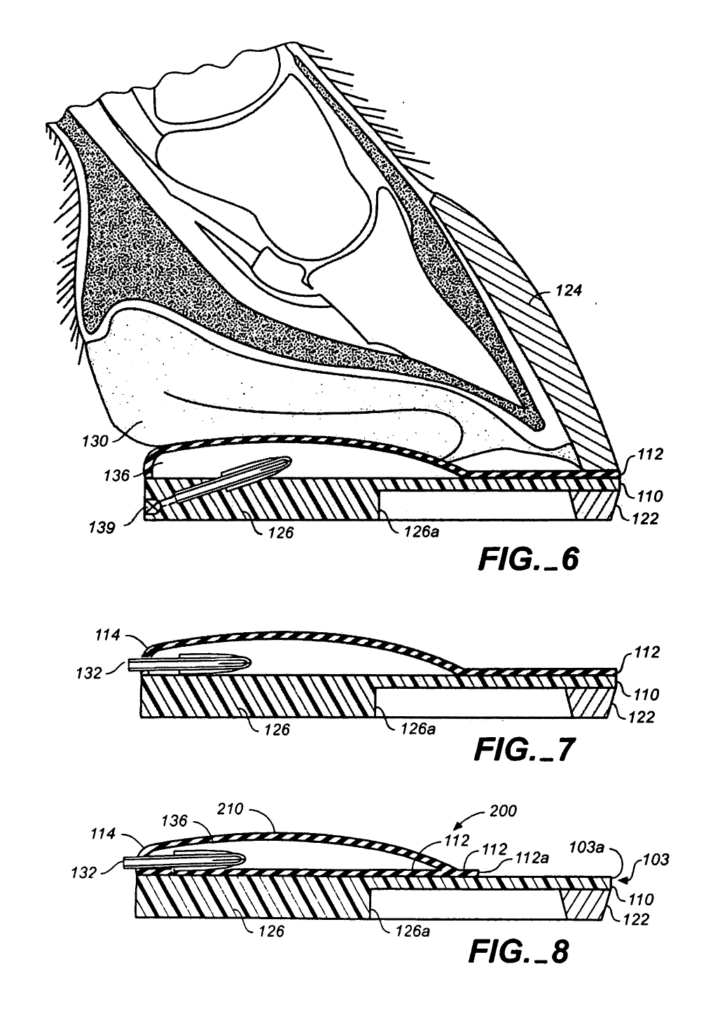

The pad preferably includes a frog pad 126, which is generally triangular in shape and tapers from the rear edge of the body member to a point generally proximate the fore portion 128 of the frog 130 when installed. As shown in FIG. 6, a valve 132 is disposed in the rear portion of the body member, preferably in the material formed by the junction of the frog pad 126 and the first layer 110, and includes a passage 134 extending through the first and second layers to the bladder chamber 136. FIG. 7 shows an alternative location for the valve 132. If desired, the valve may be disposed in the rear side 114 of the bladder 108 and not coupled to the frog pad 126.

FIG. 8 is a cross-sectional side view in elevation showing a second preferred embodiment of the inventive apparatus. In this embodiment, the second layer 112 extends under and forms the base of the bladder chamber 136. The forward most point 112a of the second layer may extend forwardly to the forward most point 103a of the toe portion 103, or it may terminate well short of that point more proximate the tip 126a of the frog pad 126. The bladder portion 210 is a discrete element and may be made to be detachable from the first layer 110 of elastomeric material. The second preferred embodiment of the inflatable horseshoe support pad of the present invention thus comprises two distinct and selectively separable pieces that form an assembly that provides the advantages described above. They can do so either as separable pieces or, alternatively, the bladder portion can be welded onto the first layer and fitted as a single piece to a horse's hoof in the shoeing process.

While each of the pad layers is preferably fabricated from resilient materials, the first layer and the frog pad (if integral) are fabricated of materials having a higher durometer value than that of the second layer. Because the first layer is attached to the horseshoe, it must be made of a material that is able to withstand the extremely high forces that are applied to the hoofs as the horse runs. Similarly, because the frog and/or flat pad are exposed to high impact forces, they should also be made of a high strength material. The material requires very high resistance to wear and abrasion as well as very high impact strength to absorb the forces excerpted by the horse's hooves. An example of such a high impact strength material is Polystone® which is an ultra-high molecular weight polyethylene (UHMW-PE) manufactured by Rochling Engineering Plastics. Although the UHMW-PE is described as a very hard material, it also has some elasticity and would be a hard elastic material. In other embodiments, the first layer and frog and/or flat pad may be made of other materials that have high impact strength.

The second layer may be substantially thinner and more flexible than the first, which is essentially rigid relative to the second layer. In an embodiment, second layer is made of a flexible elastic rubber or plastic material such as butyl or nitrile. Accordingly, when compressible gas or resilient material is injected into the bladder via valve 132, the bladder will fill and stretch the second layer upwardly and away from the first layer. Because the first layer and frog and/or flat pad are made of a more rigid material, the downward bulging in the first layer, if any at all, will be nominal.

The described embodiments of the inventive apparatus may be employed to prevent and to therapeutically treat hoof and leg maladies, including founder, navicular syndrome and other problems of lameness. In an embodiment, the inventive inflatable horseshoe support pad is interposed between a conventional horseshoe and a hoof and the bladder is inflated with a compressible gas or resilient compressible material. The bladder is then refilled or the pressure within the bladder is released as required to provide the desired frog protection and support as time passes. The hoof responds to the inventive apparatus by resisting equine diseases of laminitis and other problems of lameness. If the horse is using the inventive apparatus for treatment, the hoof continues to grow.

The full method of installing the inventive therapeutic apparatus includes the steps of: (a) providing an inflatable horseshoe support pad; (b) providing a horseshoe; (c) interposing the inflatable horseshoe support pad between the horseshoe and a horse's hoof so as to position the inflatable bladder chamber under the horse's frog; (d) nailing the horseshoe to the horse's hoof; (e) trimming the nail ends, as needed; (f) trimming the planar body member of the inflatable horseshoe pad so that its outside edge is substantially flush with the outside edge of the horseshoe; (g) inflating the bladder chamber with compressible gas or resilient material; and (h) refilling or releasing air as required over time to provide the desired frog protection.

As will be readily appreciated by those with skill in the art, in its most essential aspect, the inventive apparatus is an inflatable horseshoe support pad having a body member with a toe portion, a heel portion, an upper, hoof-facing surface and a lower, ground-facing surface. The inventive apparatus further includes an inflatable bladder which is disposed on the upper surface of the body member near or proximate the heel portion. When installed on a horse's hoof and inflated, the bladder engages the frog of the horse's hoof and provides supplemental cushioning when installed on the hoof, the bladder including a bladder chamber for filling with gas. The inflatable horseshoe pad could be provided to the user with the bladder pre-filled. However, it is preferable that a valve in fluid communication with the bladder chamber also be provided, so that the user can adjust bladder pressure according to the preventative or therapeutic needs and response of the horse.

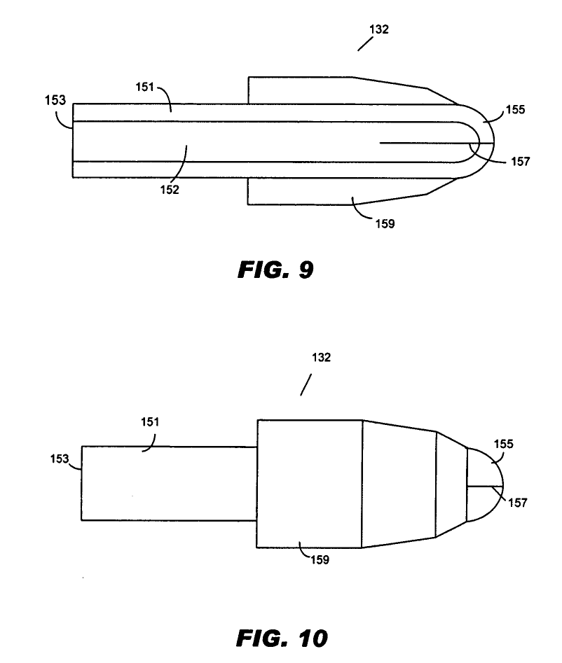

With reference to FIG. 9, a side elevation cross section of the valve 132 is illustrated and FIG. 10, a side elevation of the valve 132 is illustrated. The valve 132 has an inner valve stem 151 that is an elongated cylinder having a center bore 152, an open end 153 and a sealing end 155. The sealing end 155 is closed but there is a slot 157 in the sealing end that can be opened to allow gas or liquids to be injected into the bladder chamber 136. The slot 157 may be only on one side of the valve stem 151 or may extend between opposites sides of the stem 151. The slot 157 is defined by two smooth sealing surfaces that form a gas tight seal when the slot 157 is closed.

The valve may also include a sleeve 159 that surrounds a portion of the valve stem 151 close to the sealing end 155. The valve sleeve 159 provides support for the valve stem 151 and protects the sealing end 155. The valve sleeve 159 may also overlap the slot 157 and help to close and seal the slot 157 and prevent leakage.

The sealing end 155 of the valve 132 is coupled to the bladder chamber. When the bladder chamber is pressurized the internal pressure is higher than ambient pressure, so that the pressure on the outer surfaces of the valve stem 151 is higher than the pressure in the center of axis of the valve stem 151. This higher pressure on the outer surfaces of the sealing end will tend to hold the slot 157 closed and prevent gas or fluids from exiting the valve 132. In order for the valve 132 to function properly, the valve stem 151 is made of a flexible material that is easily opened at the sealing end 155 and seals tightly when closed. Conversely, if the pressure in the center bore 152 is greater than the pressure within the bladder chamber, the pressure differential may open the slot 157 allowing fluid to flow into the bladder from the center bore 152.

The valve 132 may also include a valve sleeve 159 that protects the valve stem 151. Because the valve sleeve 159 does not need to move, it is made of a harder material than the valve stem 151, such as a hard rubber, plastic, metal or ceramic. The sleeve 159 may be attached to the valve stem 151 in many different ways. In an embodiment, an adhesive is used to attach the valve sleeve 159 to the valve stem 151 or the rubber may be partially melted to fuse the valve components together. The sleeve 159 may also be secured to the stem 151 with friction if the outer diameter of the valve stem 151 is larger than the inner diameter of the valve sleeve 159.

With reference to FIG. 6, because the horse runs on dirt, the open end of the valve 132 may be protected by a valve cover 139 which prevents particles from entering the valve 132. The valve cover 139 can be opened for filling of the bladder chamber 136 but preventing the valve from being clogged with dirt and small rocks. The valve cover 139 can be a small cap that is releasably attached to the horseshoe pad. The valve cover 139 may be secured to the horseshoe pad with screw threads, an interference friction fit or an adhesive.

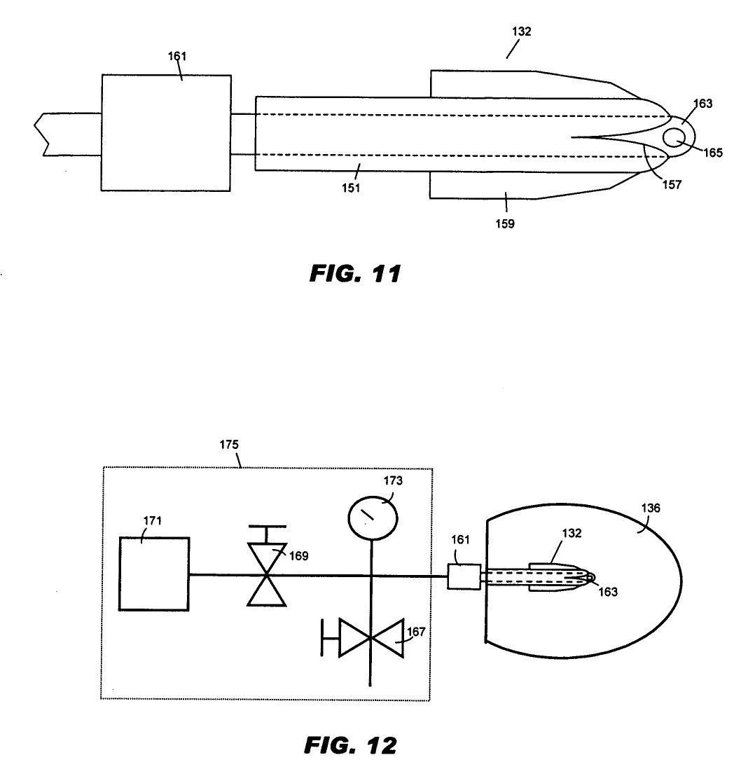

In order to properly use the inventive inflatable horseshoe support pad, a special filling mechanism is used. With reference to FIG. 11, an example of a filling mechanism 161 inserted in the valve 132 is illustrated. The filling mechanism 161 has a rigid elongated tube 163 and one or more holes 165 at the end of the tube 163. To inflate or deflate the bladder chamber 136, the metal tube 163 is inserted into the valve stem 151. Before being inserted, the metal tube 163 may be lubricated so that it slides into the valve 132 without damaging the sealing surfaces of the slot 157. When the end of the tube 163 reaches the sealing end 155, the slot 157 is opened to allow fluid to flow between the tube 163 and the bladder chamber 136. Because the outer diameter of the tube 163 is a close fit with the inner diameter of the valve stem 151, the fluid does not leak during the bladder chamber 136 filling process.

Once the elongated tube 163 is inserted into the valve stem 151, the fluid within the bladder chamber 136 can be adjusted. The pressurized bladder chamber 136 provides support for the frog and hoof. The proper pressure will depend upon the size, weight and condition of the horse. Larger and heavier horses generate larger impact loads and may require more bladder chamber 136 pressure while smaller lighter horses may use less pressure. If the inflatable horseshoe support pad is being used with a healthy horse more bladder chamber 136 pressure may be used. A horse with equine founder or laminitis may have a tender or inflamed hoof which requires less pressure within the bladder chamber 136.

The bladder pressure is controlled by filling and releasing gas from the bladder. With reference to FIG. 12, a filling system 175 is illustrated. To fill the bladder chamber 136, a gas pressure source 171 such as a compressor or a pump is used to transmitted pressurized fluid such as gas to the filling mechanism 161. In order to properly adjust the support pad, a pressure gage 173 may be used to measure the internal pressure of the bladder chamber 136. If a high pressure gas source is being used, a small valve 169 such as a needle valve can be used to regulate the gas pressure injected into the bladder chamber 136. The valve 163 is open to allow fluid into the bladder chamber 136 and closed to shut off the flow. An operator can monitor the pressure by viewing the pressure gage 173 while operating the valve 163. When the desired pressure is reached, the valve 163 is closed. A separate vent valve 167 may be attached to the filling mechanism 161 to relieve pressure in the event that the bladder chamber 136 is over pressurized. By closing valve 163 and opening the valve 167, fluid is vented from the bladder chamber 136 reducing the pressure.

Because compressors can be very large and the horse might be in a remote location, manual pumps may be used as the gas pressure source 171 to inflate the bladder chamber 136. If a manual pump is used as the gas pressure source 171 rather than a high pressure gas compressor, the user manually actuates the pump until the bladder chamber 136 is pressurized to the desired pressure. Once the bladder chamber 136 is properly pressurized, the elongated tube 163 is removed. The internal bore of the valve 132 is returned to ambient pressure and the slot 157 closes forming a gas tight seal. While the pressure control method has been described as a gas such as air, it is also possible to use any other compressible fluid such as nitrogen, foam or elastic polymers.

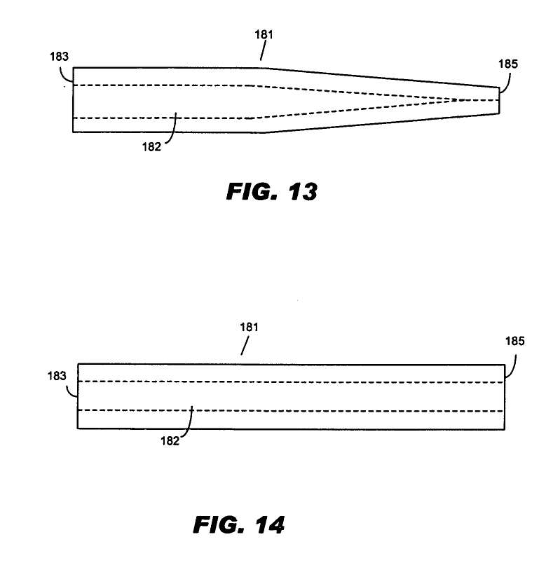

Although the valve has been illustrated as an elongated cylindrical piece with a sleeve, various other valve embodiments can be used. For example, FIG. 13 is a side elevation of an alternative valve and FIG. 14 which is a top elevation of the valve. In this alternative embodiment, the valve 181 may only include a tubular structure that is made of a flexible elastic material that transitions from a circular cross section at the open end 183 to a flat slot cross section at the sealing end 185. When the elongated metal tube of the filling device is fully inserted into the valve stem 181, the metal tube causes the slot and sealing end 185 to open. The sealing end 185 is expanded from a flat slot into a circular opening which allows fluids to flow into or out of the bladder chamber. The valve and bladder may be made of a flexible rubber compound such as Butyl rubber and the valve may also be treated with silicon for improved sealing performance.

In other embodiments, various other types of valves can be used with the present invention. Examples of such valves include “Schrader” valves that are commonly used for bicycles, motorcycle and automobile tires. A Schrader valve consists of a hollow cylindrical metal tube with a threaded end. In the center of the end is a metal pin pointing along the axis of the tube. The pin's end is approximately flush with the end of the tube. Pushing this pin into the valve opens the valve. There is an internal spring inside the Schrader valve which pushes the pin outward to close the valve when the pin is released. The valve is also held closed by internal fluid pressure.

Another possible valve this is compatible with the present invention is the Presta valve which is commonly used for bicycle tires. The Presta valve consists of three major components: the valve body, a threaded valve stem, and a lock nut. Like the Schrader valve, air pressure inside the tire holds the valve shut. The Presta does not have a return spring to help keep the valve shut. Instead, a threaded stem extends out of the valve core to hold a locking nut that can be screwed down to hold the valve closed.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like. For instance, it would be obvious to one having skill in the art to provide a different form of access to the bladder cavity than a valve. If, for instance, resilient foam were employed to provide padding rather than compressible gas, a simple flap or inlet door might function as the access means.

What is claimed is:

1. An inflatable horseshoe support pad, comprising:
a body member having a toe portion, a heel portion, a back edge, a hoof-facing side and a ground-facing side;
an inflatable bladder disposed on said hoof-facing side of the body member proximate said heel portion so as to engage the frog of a horse's hoof when installed on the hoof, the bladder including a bladder chamber that is at least partially filled with a gas or a liquid; and
a valve that includes an elongated valve stem that has an open end coupled to an outer surface of the horseshoe support pad and a sealing end coupled to the bladder chamber; wherein the bladder chamber is filled with a fluid by transmitting a compressible fluid through the valve stem into the bladder chamber.

2. The inflatable horseshoe support pad of claim 1, wherein the sealing end of the valve has a slot that seals when the internal pressure within the bladder is greater than the ambient pressure.

3. The inflatable horseshoe support pad of claim 1, wherein the valve stem is made of a flexible elastic material.

4. The inflatable horseshoe support pad of claim 1, wherein the valve further includes a valve sleeve that surrounds a portion of the valve stem.

5. The inflatable horseshoe support pad of claim 4, wherein the sleeve is made of a hard elastic material.

6. The inflatable horseshoe support pad of claim 5 wherein the hard rubber compound material is selected from the group consisting of natural rubber, synthetic rubber, plastic, and combinations thereof.

7. The inflatable horseshoe support pad of claim 1, wherein the open end of the valve stem is located proximate the back edge of the body member.

8. An inflatable horseshoe support pad system comprising:
a body member having a toe portion, a heel portion, a back edge, a hoof-facing side and a ground-facing side;
an inflatable bladder disposed on said hoof-facing side of said body member that includes a bladder chamber and is proximate said heel portion, the bladder that is at least partially filled with a compressible fluid;
a valve that includes an elongated valve stem that extends from an open end at an outer surface of the horseshoe support pad to a sealing end proximate the bladder chamber; and
a filling mechanism that includes an elongated tube that fits within the elongated valve stem.

9. The apparatus of claim 8, further comprising a frog pad coupled to the ground-facing side of the body.

10. The apparatus of claim 9, wherein the valve stem is coupled to a portion of the frog pad.

11. The apparatus of claim 8, wherein the valve further comprises a valve sleeve that surrounds a portion of the valve stem.

12. The apparatus of claim 8, wherein the valve includes a slot that is normally closed and forms a gas tight seal.

13. The apparatus of claim 8, wherein the valve is disposed in the bladder chamber.

14. A therapeutic horseshoe system for prevention and treatment of horse hoof and leg maladies, including founder and navicular syndrome, said apparatus comprising:
a planar body member having an upper side and a lower side; and
an bladder disposed on said upper side of said body member;
an elongated valve stem having a sealing end coupled to the inflatable bladder; and
a filling mechanism that includes an elongated tube and that is inserted the valve to fill the bladder with a compressible fluid.

15. The apparatus of claim 14, wherein the sealing end of the elongated valve stem includes a slot.

16. The apparatus of claim 14, further including a valve sleeve that surrounds a portion of the valve stem.

17. The apparatus of claim 16, wherein the valve sleeve is made of a more harder material than the valve stem.

18. The apparatus of claim 14, wherein the sealing end of the elongated valve stem includes a slot and a pressure differential between the bladder and ambient pressure closes the slot.

19. The apparatus of claim 18, wherein the elongated tube causes the slot to open when the elongated tube is inserted into the valve.

20. The apparatus of claim 14 wherein the filling mechanism includes a pressure gage that measures the internal pressure of the bladder.
